(19) United States
(12) Patent Application Publication
(10) Pub. No.: US 2025/0387893 A1
(43) Pub. Date: Dec. 25, 2025

(54) Method for detecting kickback of electric tool

(71) Applicant: Hilti Aktiengesellschaft, Schaan (LI)

(72) Inventor: Maryam EFTEKHARI, Untermeitingen (DE)

(21) Appl. No.: 18/877,540

(22) PCT Filed: Jun. 21, 2023
(86) PCT No.: PCT/EP2023/066769

§ 371 Date: Dec. 20, 2024

(30) Foreign Application Priority Data
Jul. 5, 2022 (EP) 22182936.9

(51) Int. Cl. B25F 5/00

(52) U.S. Cl. CPC B25F 5/00

(57) ABSTRACT

An electronic tool (1) and a method for detecting kickback of the tool (1), the electric tool (1) including a housing (2), a power supply module, an electric motor (4), a working component (3), a control module (5) and a detection module (6). The detection method (6) predicts a position of the centre of gravity (C) of the working component (3) of the electric tool (1) in the relevant immediate future by the linear speed and rotational speed of the working component (3) collected by the detection module (6), compares a displacement between the predicted position and an actual position with a pre-set threshold, and when the displacement exceeds the pre-set threshold, determines that kickback is about to occur.

### FIELD OF THE INVENTION

The present invention relates to an electric tool operating method, in particular to a method for detecting electric tool kickback, and an electric tool for performing the method.

### BACKGROUND OF THE INVENTION

Electric tools such as electric angle grinders and electric circular saws all rely on the rotation of an electric motor to drive a working component to perform a corresponding job. In the course of operation of some high-torque electric tools, such as high-power angle grinders and circular saws, when inserts such as abrasive wheels or saw blades abut a material being processed, the material being processed might exert a reaction force on the inserts and thereby cause the electric tool to become jammed or to kickback, resulting in kickback.

### SUMMARY OF THE INVENTION

Many electric tools are known in which kickback detection has been implemented. In most existing kickback detection solutions, the occurrence of kickback is determined on the basis of a comparison of an actual of an acceleration sensor and a set threshold. For example, the patent document US20180038546A has disclosed a solution that makes it possible to accurately detect kickback of an electric tool rebounding from a material being processed according to a movement of a body of the electric tool. The electric tool contains a detection module for detecting a change in the attitude of the apparatus body; when the motor is performing a driving action, if the extent of the change in attitude of the apparatus body as detected by the detection module exceeds a pre-set threshold, it is determined that the apparatus body kickbacks from the material being processed. As the extent of the change in attitude of the apparatus body, the detection module detects at least one of a speed of movement and an amount of movement of the apparatus body in one or more axial directions, and the control module is configured such that: if the speed of movement or the amount of movement detected by the detection module exceeds a threshold, it is determined that the apparatus body kickbacks from the material being processed, and the driving action of the motor is terminated. If kickback has already occurred, it may result in loss of control of the electric tool, and the operator of the electric tool might therefore be injured. Thus, there is a need for a solution that would make it possible to predict a trend of tool movement and thereby predict that kickback might occur. It would then be possible to stop the tool as quickly as possible, to avoid injury to the tool operator.

Furthermore, in the prior art, it is often not possible to distinguish between true kickback and manual kickback detection. In some situations, it can be tested manually for an office show of the kickback feature or in case of user test a kickback detection function, no true kickback occurs—it is merely a manual test. In such cases, it is desired that the electric tool be able to identify whether it is true kickback or a manual test, and thereby use different braking schemes, in order to avoid wear to mechanical components due to hard braking.

An objective of the present invention is to provide a method for detecting kickback of an electric tool, which can predict and accurately detect the occurrence of kickback and can reduce the risk of injury to the user of the electric tool and of damage to the electric tool.

Another objective of the present invention is to provide an electric tool and a method for detecting kickback of the electric tool, to distinguish between true kickback and a manual kickback test.

In addition, the present invention further provides an electric tool for performing the kickback method.

To achieve the above objective, the technical solution of the present invention is as follows:

A method for detecting kickback of an electric tool, the electric tool comprising a housing, a power supply module, an electric motor, a working component, a control module and a detection module, the detection module being designed to detect a linear acceleration and an angular velocity of the working component, and the detection module being separated from the centre of gravity of the working component by a distance r; the detection method comprises:
a. detecting the linear acceleration by means of the detection module, subtracting gravitational acceleration from the linear acceleration to form an adjusted linear acceleration; then integrating the adjusted linear acceleration to obtain a linear speed;
b. detecting the angular velocity by means of the detection module, and multiplying by the distance r between the detection module and the centre of gravity of the working component to obtain a rotational speed;
c. calculating a total translational speed based on the linear speed and the rotational speed, predicting a position of the centre of gravity of the working component of the electric tool after a time constant r milliseconds;
d. detecting an actual position of the centre of gravity of the working component of the electric tool;
e. comparing a displacement between the predicted position of the centre of gravity of the working component and an actual position of the centre of gravity of the working component with a pre-set threshold, and when the displacement exceeds the pre-set threshold, determining that kickback is about to occur.

The method for detecting kickback of an electric tool according to the present invention only needs to collect acceleration and angular velocity signals of the electric tool in order to predict, simply and reliably, whether the electric tool will suffer kickback imminently, in order to rapidly brake or stop the electric motor timely, thus being able to protect the user from injury due to electric tool kickback in a simple way.

In the method for detecting kickback according to the present invention, the predicted position of the centre of gravity of the working component of the electric tool after τ milliseconds is calculated by the following equation:

$$s ( t + τ ) = s ( t ) + v ( t ) \cdot τ + \frac{1}{2} \cdot {τ}^{2} \cdot a ( t )$$

where s(t+τ) represents the predicted position, s(t) represents the actual position, v(t) represents the vector sum of the linear speed and the rotational speed, and α(t) represents the linear acceleration. Thus, the predicted position of the centre of gravity of the working component is the position after τ milliseconds, based on the actual position. The method of the present invention is independent of electric motor current or rotational speed information and does not need to compare changes in acceleration, instead determining that the electric tool is about to suffer kickback by predicting the position of the electric tool in the relevant immediate future. Predicting the trend of motion of the centre of gravity of the working component is the most accurate method of judging the position of the electric tool, in order to more accurately predict whether kickback will occur.

According to a preferred embodiment of the present invention, the linear accelerations are filtered, in order to eliminate noise arising during operation of the electric tool.

According to another preferred embodiment of the present invention, the pre-set threshold for a safe area for the user is fixed. This means that the detection module and control module of the present invention can operate without any further information; that is to say, signals other than acceleration and rotational speed signals, such as electric motor current or speed, are not required information for detection of kickback in the electric tool of the present invention.

According to another preferred embodiment of the present invention, the detection method further collects rotational speed and/or current signals from the electric motor, and the pre-set threshold can change according to the rotational speed or current from the electric motor. For example, when there is an obvious drop in the rotational speed of the electric motor, the pre-set threshold for a safe region of the user may be adjusted.

According to another preferred embodiment of the present invention, the detection method further comprises: if an obvious drop in the rotational speed or an obvious increase in current of the electric motor is detected at the same time as the displacement exceeds the pre-set threshold, this is determined as being true kickback; otherwise, if there is no obvious change in the rotation speed or current of the electric motor, this is determined as being a manual kickback test. In the case of true kickback, there will also be an obvious drop in the speed of the tool. This means that if there is an obvious drop in speed when kickback is detected, the threshold of the prediction equation can be adjusted, meaning faster kickback detection, in order to select a suitable braking method. In the case of a manual kickback test, the electric motor speed will not drop, making it possible to distinguish between true and non-true kickback situations. Thus, very fast braking can be avoided, in order to avoid wear to mechanical components due to hard braking.

In addition, the present invention further provides an electric tool, comprising a housing, a power supply module, an electric motor, a working component, a control module and a detection module, the detection module being designed to detect linear acceleration and angular velocity of the centre of gravity of the working component, and the detection module being separated from the centre of the working component by a distance r; the electric tool is designed to perform the method for detecting kickback described in greater detail above. The advantages expounded in relation to the detection method according to the present invention also correspondingly apply to the electric tool designed according to the present invention. By using the electric tool designed according to the present invention, it is thus possible to predict the occurrence of electric tool kickback simply and reliably, in order to prevent injury to the user.

Preferably, in the electric tool according to the present invention, the detection module comprises an acceleration sensor for determining linear acceleration in three specific spatial directions, and a gyroscope sensor for determining angular velocity in three spatial directions.

According to a preferred embodiment of the present invention, the working component comprises a saw blade, or a drill bit, or an abrasive wheel. The electric tool of the present invention includes but is not limited to tools for grinding, hammer-drilling or cutting, specifically, electric tools such as angle grinders, circular saws, scroll saws or sabre saws, drills, hammer drills or chisel hammer drills. Thus, the working component also correspondingly comprises a saw blade, or a drill bit, or an abrasive wheel, etc. for the abovementioned electric tools. The choice of the working component should be matched to the electric tool. The centre of gravity of the working component is preferably located at the centre of the saw blade, or a working axis of the drill bit, or the centre of the abrasive wheel.

### BRIEF DESCRIPTION OF THE FIGURES

The embodiments mentioned can be better understood through the following detailed description while the drawings are read. It is emphasized that the various components are not necessarily drawn to scale. In fact, dimensions can be enlarged or reduced at will for the purpose of clear discussion. In the drawings, the same reference numerals refer to the same elements.

FIG. 1 is a simplified structural schematic drawing of the electric tool provided in an embodiment of the present invention.

FIG. 2 is a flow chart of the method for detecting electric tool kickback provided in the present invention.

### DETAILED DESCRIPTION

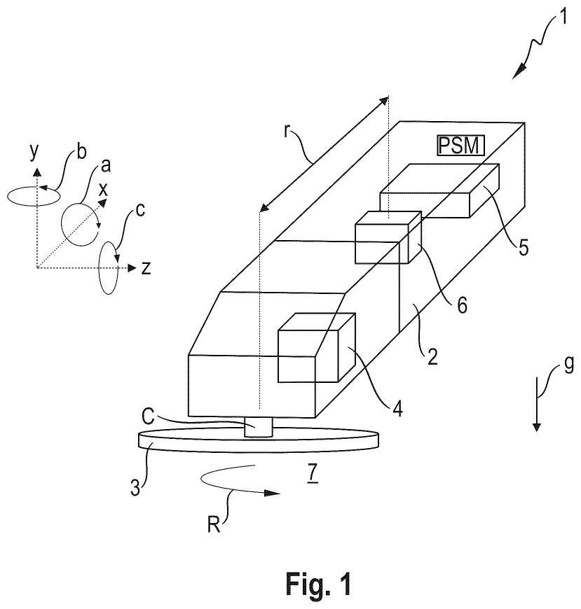

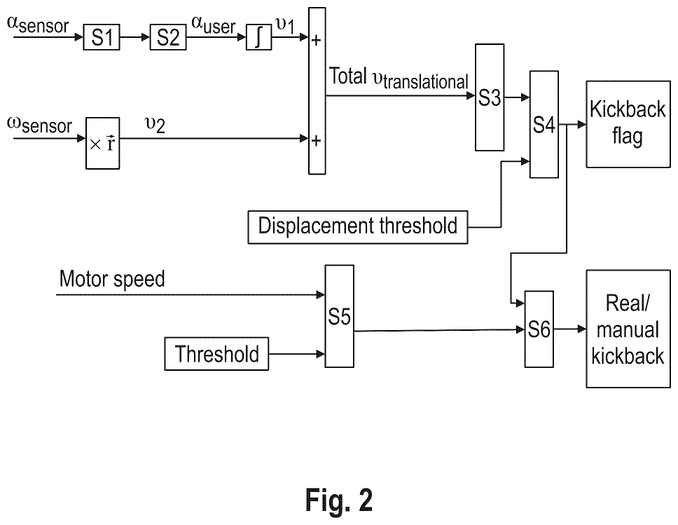

The electric tool and electric tool kickback detection method of the present invention are described below with reference to FIGS. 1 and 2.

FIG. 1 shows an electric tool 1 according to the present invention, designed as an angle grinder in the illustration shown. According to alternative embodiments, the electric tool 1 may also be designed as a drill, a hammer drill, a chisel hammer drill or a saw, such as a circular saw, a scroll saw or a sabre saw, etc. Preferably, the electric tool 1 of the present invention is a handheld electric tool.

The electric tool 1 designed as an angle grinder in FIG. 1 comprises a housing 2, a power supply module PSM shown schematically, a working component 3, an electric motor 4, a control module 5, and a detection module 6. The housing 2 preferably has at least one handle region, in which the user can grip and operate the electric tool 1. The electric motor 4 is supplied with a current by means of the power supply module connected to the electric tool 1. The power supply module may be a storage battery for a cordless tool, and alternatively may be a power supply cable for a corded tool. The electric motor 4 is arranged in the interior of the housing 2 together with a gear mechanism and a drive shaft 7, for the purpose of driving the working component 3, e.g. abrasive wheel, to perform a working process, by rotation, axial motion, rotary motion or similar motion. For example, in this embodiment, torque produced by the electric motor 4 is transmitted to the gear mechanism and finally transmitted to the drive shaft 7. The centre of the working component 3, e.g. abrasive wheel, is connected to the drive shaft 7, therefore the torque of the drive shaft 7 can be transmitted to the working component 3, so that the working component 3 can rotate in the direction of the arrow R.

The electric tool 1 also has the control module 5 and the detection module 6. The detection module 6 is electrically connected to the control module 5, or alternatively is wirelessly connected thereto. Signals can be sent between the detection module 6 and the control module 5. The control module 5 is in turn connected to the electric motor 4 and the power supply module, or alternatively is wirelessly connected thereto. Signals can be sent between the detection module 6 and the electric motor, and between the detection module and the power supply module.

According to a preferred embodiment of the present invention, the detection module 6 is designed as a hybrid acceleration and/or gyroscope sensor. In alternative embodiments, it is also possible to only provide an acceleration sensor, or an acceleration sensor and a gyroscope sensor that are separate. In this embodiment, the detection module 6 is designed to be able to detect a linear acceleration α_sensor in three axial directions in 3D space, i.e. on the x-axis, y-axis and z-axis. In addition, the detection module 6 may also detect angular velocity ω_sensor in the directions of rotation about the rotation axis x, y, and z.

If the working component 3 designed as an abrasive wheel becomes jammed in the material to be processed while performing a working process, the working component 3 will no longer rotate relative to the material to be processed, and the torque produced by the electric motor 4 will act on the housing 2 of the electric tool 1. As a result, the housing 2 will begin to accelerate or be displaced around the rotation axis y, in a direction opposite to the rotation direction R. This sudden acceleration or sudden displacement of the housing 2 of the electric tool 1 might be dangerous to the user. To prevent the abrasive wheel from injuring the user or another person, the control module 5 will shut off the electric motor as quickly as possible with the aid of a detected by the detection module 6 and an equation stored in the control module 5 and described by the method according to the present invention, when sudden acceleration or sudden displacement of the housing 2 of the electric tool 1 is detected.

As shown in FIG. 1, the detection module 6 is generally disposed in the handle region of the housing 2 in the longitudinal direction x of the electric tool 1. The detection module 6 is thus separated from the centre of gravity C of the working component 3 by a distance r. Alternatively, the detection module 6 is disposed at the centre of gravity C of the working component 3, in which case the distance r is equal to zero.

Referring to FIG. 2, the kickback detection method of the present invention specifically comprises the following: detection of at least one linear acceleration by means of the detection module 6. Preferably, the detection module 6 detects linear acceleration α_x in direction x axis, α_y in direction y axis, and α_z in direction z axis. As is well known, the directions x, y and z defined in 3D space are perpendicular to each other; the x direction corresponds to the longitudinal direction of the electric tool 1, the y direction corresponds to the vertical direction of the electric tool 1, and the z direction corresponds to the transverse direction of the electric tool 1. The linear acceleration α_x, α_y and α_z in the three directions are integrated as the linear acceleration α_sensor.

Preferably, when the electric tool 1 is operating, e.g. during grinding, cutting, sawing or drilling, etc., disturbances such as fierce vibration and noise might occur, leading to undesired shut-off of the electric tool 1. In order to be able to avoid such a situation in a simple manner, as represented by S1 shown in FIG. 2, the measured acceleration α_sensor is filtered. For example: a low-pass filter may be provided, wherein a typical frequency for low-pass filtering is between 0.1 Hz and 6 Hz, and is specifically about 1 Hz. In an electric tool 1 specifically having an oscillating working component 3 such as a saw, interference signals might affect rotational speed values, and it is possible to use a low-pass or band-pass filter to filter these values. The frequencies of these filters are adapted to the frequencies of oscillatory motion, such that the filters are damped to the desired degree.

In addition, the gravitational acceleration (g=9.81 m/s2) detected by the detection module 6 acts on the electric tool 1 perpetually. Since this is destructive for determining a critical state of the electric tool 1, as represented by S2 in FIG. 2, the relevant component parts of the gravitational acceleration g of are subtracted from the first, second and third linear acceleration, thereby forming an adjusted linear acceleration α_user. Specific algorithms for removing the gravitational acceleration are known; for example, reference may be made to the method disclosed in CN114174002, published in English as US 2022/0324092A1. The adjusted linear acceleration α_user is then integrated to obtain a linear speed v1.

In parallel with the step described above, the detection module 6 detects at least one angular velocity. Preferably, the detection module 6 detects angular velocity ω_x, ω_y and ω_z in three spatial directions, i.e. on the x-axis, y-axis and z-axis, and integrates these as an angular velocity ω_sensor. This angular velocity ω_sensor is multiplied by the distance r between the detection module and the centre of the working component to obtain a rotational speed v2.

Then, as represented by S3 in FIG. 2, the position of the centre of gravity of the working component of the electric tool after τ milliseconds is predicted base on equation:

$$s ( t + τ ) = s ( t ) + v ( t ) \cdot τ + \frac{1}{2} \cdot {τ}^{2} \cdot a ( t )$$

In this equation, total speed Total vₜᵣₐₙₛₗₐₜᵢₒₙₐₗ, linear acceleration, and actual position of the centre of gravity of the working component are used for prediction after T milliseconds, where s(t+τ) represents the predicted position, s(t) represents the actual position, v(t) represents the total speed Total vₜᵣₐₙₛₗₐₜᵢₒₙₐₗ, and α(t) represents the linear acceleration. Herein, Total vₜᵣₐₙₛₗₐₜᵢₒₙₐₗ is the vector sum of the linear speed v1 and the rotational speed v2. The time constant τ may be a fixed time period between 50 ms and 100 ms, and it may be specifically about 70 ms.

The displacement between the predicted position of the centre of gravity of the working component 3 and the actual position of the centre of gravity of the working component 3 is compared with a pre-set displacement threshold, as represented by S4 in FIG. 2; when the displacement exceeds the pre-set displacement threshold, it is determined that kickback is about to occur. The method of the present invention is independent of the current or rotational speed information from electric motor 4 and does not need to compare changes in acceleration, instead determining that the electric tool is about to suffer kickback by predicting the position of the electric tool 1 in the relevant immediate future. Predicting the trend of motion of the centre of gravity of the working component 3 is the most accurate method of judging the position of the electric tool 1, in order to more accurately predict whether kickback will occur.

According to another preferred embodiment of the present invention, the pre-set displacement threshold is fixed. This means that the detection module 6 and control module 5 of the present invention can operate without any further information; that is to say, signals other than acceleration and rotational speed of the working component 3, such as electric motor current or rotational speed of the electric motor 4, are not required information for detection of kickback in the electric tool 1 of the present invention.

Alternatively, according to another preferred embodiment of the present invention, the pre-set threshold may change according to rotational speed or current signals from the electric motor 4. The pre-set displacement threshold for a safe region of the user may be adjusted.

According to another preferred embodiment of the present invention, the detection method further comprises: the detection method further collects rotational speed and/or current signals from the electric motor 4, and as shown by S5, if an obvious drop in the rotational speed or an obvious increase in current of the electric motor 4 is detected, a logic assessment will be conducted. As represented by S6 in FIG. 2, if the displacement of the working component 3 exceeds the pre-set displacement threshold at the same time, this is determined as being true kickback; otherwise, if there is no obvious change in the rotational speed or current of the electric motor 4, this is determined as being a manual kickback test. In the case of true kickback, the threshold of the prediction equation can be adjusted, in order to select a suitable braking method. For example, the control module 5 will act to brake or stop the electric motor, and/or send an alarm signal when true kickback is determined. In the case of a manual kickback test, the electric motor 4 rotational speed will not drop, making it possible to distinguish true kickback from kickback testing situations. Thus, very fast braking can be avoided, in order to avoid wear to mechanical components due to hard braking.

As mentioned above, although exemplary embodiments of the present invention have been described herein with reference to the drawings, the present invention is not limited to the particular embodiments above and can have many other embodiments. The scope of the present invention shall be defined by the claims and their equivalent meaning.

1-11. (canceled)

12. A method for detecting kickback of an electric tool, the electric tool having a housing, a power supply module, an electric motor, a working component, a control module and a detection module, the detection module being designed to detect a linear acceleration and an angular velocity of the working component, and the detection module being separated from the centre of gravity of the working component by a distance r, the detection method comprising:
a. detecting the linear acceleration via the detection module, subtracting gravitational acceleration from the linear acceleration to form an adjusted linear acceleration; then integrating the adjusted linear acceleration to obtain a linear speed;
b. detecting the angular velocity via the detection module, and multiplying by the distance r between the detection module and the centre of gravity of the working component to obtain a rotational speed;
c. calculating a total translational speed based on the linear speed and the rotational speed, predicting a position of the centre of gravity of the working component of the electric tool after a time constant τ milliseconds;
d. detecting an actual position of the centre of gravity of the working component of the electric tool; and
e. comparing a displacement between the predicted position of the centre of gravity of the working component and the actual position of the centre of gravity of the working component with a pre-set threshold, and when the displacement exceeds the pre-set threshold, determining that kickback is about to occur.

13. The method as recited in claim 12 wherein the predicted position of the centre of gravity of the working component of the electric tool after τ milliseconds is calculated by the following equation:
$$s ( t + τ ) = s ( t ) + v ( t ) \cdot τ + \frac{1}{2} \cdot {τ}^{2} \cdot a ( t )$$
where s(t+τ) represents the predicted position, s(t) represents the actual position, v(t) represents the vector sum of the linear speed and the rotational speed, and α(t) represents the linear acceleration.

14. The method as recited in claim 13 wherein the detection module detects linear acceleration or angular velocity in three spatial directions, including on an x-axis, a y-axis and a z-axis.

15. The method as recited in claim 14 wherein the linear accelerations in the three spatial direction are filtered.

16. The method as recited in claim 15 wherein the pre-set threshold is fixed.

17. The method as recited in claim 15 further comprising collecting rotational speed or current signals from the electric motor, and changing the pre-set threshold according to the rotational speed or current from the electric motor.

18. The method as recited in claim 17 further comprising: if a drop in the rotational speed or an increase in the current of the electric motor is detected at the same time as the displacement exceeds the pre-set threshold, this is determined as being true kickback; otherwise, if there is no obvious change in the rotational speed or current of the electric motor, this is determined as being a manual kickback test.

19. The method as recited in claim 18 further comprising braking or stopping the electric motor or issuing an alarm signal when true kickback is determined.

20. An electric tool comprising:
a housing;
a power supply module;
an electric motor;
a working component;
a control module; and
a detection module, the detection module being designed to detect at least one linear acceleration or at least one angular velocity of the working component, the detection module being separated from the centre of the working component by a distance r, the electric tool performing the method for detecting kickback as recited in claim 12.

21. The electric tool as recited in claim 20 wherein the detection module includes an acceleration sensor for determining linear acceleration in three specific spatial directions, and a gyroscope sensor for determining angular velocity in three spatial directions.

22. The electric tool as recited in claim 20 wherein the working component includes a saw blade, a drill bit, or an abrasive wheel.
